(19) United States
(12) Patent Application Publication
(10) Pub. No.: US 2009/0014264 A1
(43) Pub. Date: Jan. 15, 2009

(54) Hydraulic shock absorber

(75) Inventor: Tsutomu Yoshimoto, Tokyo (JP)

Correspondence Address: RABIN & Berdo, PC, 1101 14TH STREET, NW, SUITE 500, WASHINGTON, DC, 20005, US

(73) Assignee: KAYABA INDUSTRY CO., LTD., Tokyo (JP)

(21) Appl. No.: 12/216,749

(22) Filed: Jul. 10, 2008

(30) Foreign Application Priority Data
Jul. 12, 2007 (JP) 2007-183487

(51) Int. Cl. F16F 9/19

(52) U.S. Cl. 188/314

(57) ABSTRACT

In a hydraulic shock absorber, a first oil chamber (R1) around the piston rod (2) and a second oil chamber (R2) on the opposite side are separated by a piston (3). A communicating passage (L) is disposed on the outside of the cylinder (1) to connect the first oil chamber (R1) and the second oil chamber (R2). An elongation damping valve (4) is installed in the communicating passage (L). When the piston (3) performs an elongation stroke, the entire amount of working oil that has flowed out from the first oil chamber (R1) is supplied to the second oil chamber (R2) via the elongation damping valve (4). As a result, the second oil chamber (R2) does not suffer a shortage of working oil and when the piston (3) shifts to the contraction stroke, a response in generation of damping force can be improved.

### FIELD OF THE INVENTION

This invention relates to a hydraulic shock absorber which is, for example, disposed between a vehicle body and a wheel to absorb oscillation of the wheel due to road surface undulation.

### BACKGROUND OF THE INVENTION

JP2002-227906A, published by the Japan Patent Office in 2002, discloses a hydraulic shock absorber which supports a rear wheel of a motorcycle and absorbs oscillation of the rear wheel due to road surface undulation.

The hydraulic shock absorber comprises a piston accommodated in a cylinder and a piston rod connected to the piston so as to protrude from the cylinder in an axial direction. The inner space of the cylinder is separated by the piston into a first oil chamber which is formed around the piston rod and a second oil chamber which is formed on the opposite side of the piston to the first oil chamber. Working oil is enclosed in these oil chambers.

In the following description, a stroke of the piston within the cylinder in a direction to contract the second oil chamber and expand the first oil chamber is named as a contraction stroke. A stroke of the piston within the cylinder in a direction to contract the first oil chamber and expand the second oil chamber is named as an elongation stroke.

The piston is equipped with an elongation damping valve which allows the working oil to flow from the contracting first oil chamber to the expanding second oil chamber under a predetermined damping force when the piston performs an elongation stroke, and a contraction damping valve which allows the working oil to flow from the contracting second oil chamber to the expanding first oil chamber under a predetermined damping force when the piston performs a contraction stroke. The damping valves also have a function for preventing the working oil from flowing in the opposite direction.

The second oil chamber is connected to a reservoir provided outside of the cylinder via a contraction sub-valve and a check valve which are disposed in parallel with each other. When the piston performs a contraction stroke, an amount of working oil corresponding to a volume by which the piston rod has invaded the cylinder has to be expelled from the cylinder. This surplus working oil flows out from the second oil chamber to the reservoir via the contraction sub-valve while generating a predetermined contraction damping force. When, on the other hand, the piston performs an elongation stroke, an amount of working oil corresponding to a volume by which the piston rod has protruded from the cylinder, is supplied to the second oil chamber from the reservoir via the check valve.

In this hydraulic shock absorber, the first oil chamber and the reservoir are connected by a communicating passage in which a variable orifice is installed so as to adjust the elongation damping force. When the piston performs an elongation stroke, the variable orifice allows the working oil to flow from the contracting first oil chamber to the reservoir. When the elongation stroke is performed at a low speed, the variable orifice generates a smaller damping force than the elongation damping valve while keeping the elongation damping valve inoperative. In other words, the variable orifice has a function for preventing an excessive damping force from being generated when the piston operates at a low speed. The flow cross-sectional area of the variable orifice can be varied by an operation thereof from outside.

### SUMMARY OF THE INVENTION

In the hydraulic shock absorber according to the prior art, when the piston performs an elongation stroke at a high speed, the working oil in the contracting first oil chamber flows out to the reservoir via the variable orifice as well as to the second oil chamber via the elongation damping valve.

Working oil in the reservoir is also supplied to the enlarging second oil chamber via the check valve. If all the oil which has flowed out from the contracting first oil chamber flows into the second oil chamber via the elongation damping valve, the amount of oil which is supplied from the reservoir to the second oil chamber is identical to the volume by which the piston has protruded from the cylinder, as described above. However, in the hydraulic shock absorber according to the prior art, a part of working oil in the contracting first oil chamber flows into the reservoir via the variable orifice. The amount of oil supplied from the reservoir to the second oil chamber therefore corresponds to the sum of the oil amount corresponding to the volume by which the piston rod has protruded from the cylinder and the oil amount which has flowed out from the first oil chamber into the reservoir via the variable orifice.

Accordingly, in the hydraulic shock absorber according to the prior art, a large amount of working oil is supplied from the reservoir to the second oil chamber via the check valve when the piston performs an elongation stroke. When the elongation stroke of the piston is performed at a very high speed, therefore, the supply amount of working oil to the second oil chamber from the reservoir falls short. When the supply amount of working oil to the second oil chamber falls short, the pressure in the second oil chamber may fall to a negative pressure. When the piston shifts from the elongation stroke to the contraction stroke in this state, a delay in a pressure increase in the second oil chamber occurs, and a specified contraction damping force characteristic cannot be obtained during this delay period.

It is therefore an object of this invention, to ensure a high response in damping force generation when the piston shifts from the elongation stroke to the contraction stroke.

It is a further object of this invention to realize easy adjustment of the damping force of a damping valve.

In order to achieve the above objects, this invention provides a hydraulic shock absorber comprising a cylinder, a piston accommodated in the cylinder, a piston rod connected to an end of the piston and protruding axially from the cylinder, a first oil chamber separated by the piston around the piston rod within the cylinder, a second oil chamber separated by the piston on the opposite side of the piston to the piston rod, a communicating passage disposed on the outside of the cylinder to connect the first oil chamber and the second oil chamber, and an elongation damping valve installed in the communicating passage to allow a working to flow from the first oil chamber to the second oil chamber under a predetermined damping force while preventing the working oil from flowing in the opposite direction.

The details as well as other features and advantages of this invention are set forth in the remainder of the specification and are shown in the accompanying drawings.

### BRIEF DESCRIPTION OF THE DRAWINGS

FIG. 1 is a hydraulic circuit diagram of a hydraulic shock absorber according to this invention.

FIG. 2 is a hydraulic circuit diagram of a hydraulic shock absorber according to the prior art.

FIGS. 3A and 3B are a longitudinal sectional view of essential parts of a hydraulic shock absorber according to a further embodiment of this invention.

### DESCRIPTION OF THE PREFERRED EMBODIMENTS

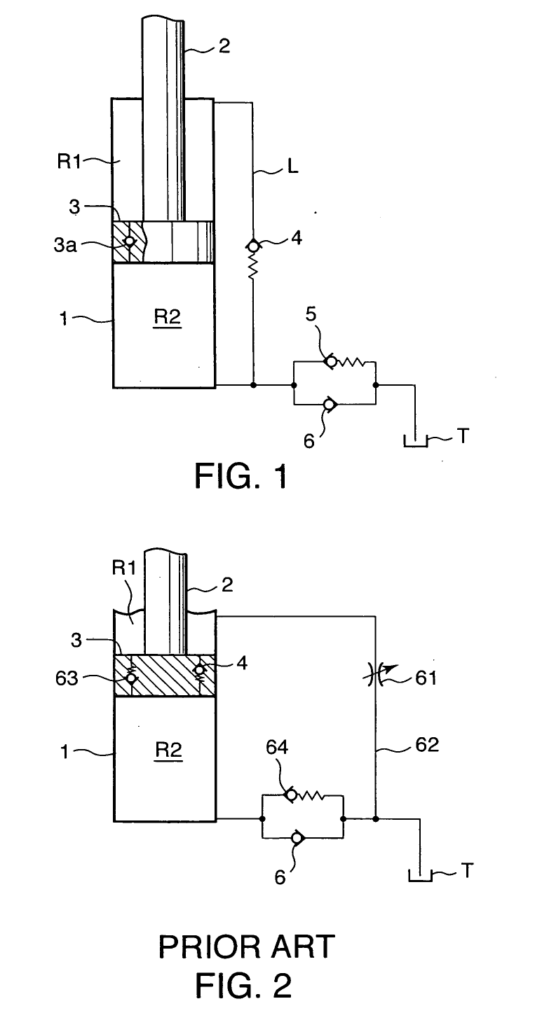

Referring to FIG. 1 of the drawings, a hydraulic shock absorber according to this invention comprises a cylinder 1, a piston 3 accommodated in the cylinder 1, and a piston rod 2 connected to an end of the piston 3 and protruding from the cylinder 1 in an axial direction.

The interior of the cylinder 1 is separated by the piston 3 into a first oil chamber R1 which is formed around the piston rod 2 and a second oil chamber R2 formed on the opposite side of the piston 2 to the first oil chamber R1. The oil chambers R1, R2 are filled with working oil.

The piston 3 is provided with a check valve 3a which allows the working oil to flow from the second oil chamber R2 to the first oil chamber R1 while preventing the working oil from flowing in the opposite direction. The check valve 3a may be referred to as a second check valve.

The first oil chamber R1 is connected to the second oil chamber R2 via a communicating passage L provided outside the cylinder 1. An elongation damping valve 4 is installed in the communicating passage L. The elongation damping valve 4 allows the working oil to flow from the first oil chamber R1 to the second oil chamber R2 under a predetermined resistance, or in other words under a predetermined damping force, while preventing the working oil from flowing in the opposite direction.

The second oil chamber R2 and a tank T that serves as a reservoir are connected via a contraction damping valve 5. The contraction damping valve 5 allows the working oil to flow from the second oil chamber R2 to the tank T under a predetermined resistance, or in other words under a predetermined damping force, while preventing the working from flowing in the opposite direction. In parallel with the contraction damping valve 5, a check valve 6 connects the second oil chamber R2 and the tank T. The check valve 6 allows the working oil to flow from the tank T to the second oil chamber R2 while preventing the working oil from flowing in the opposite direction. The check valve 6 may be referred to as a first check valve.

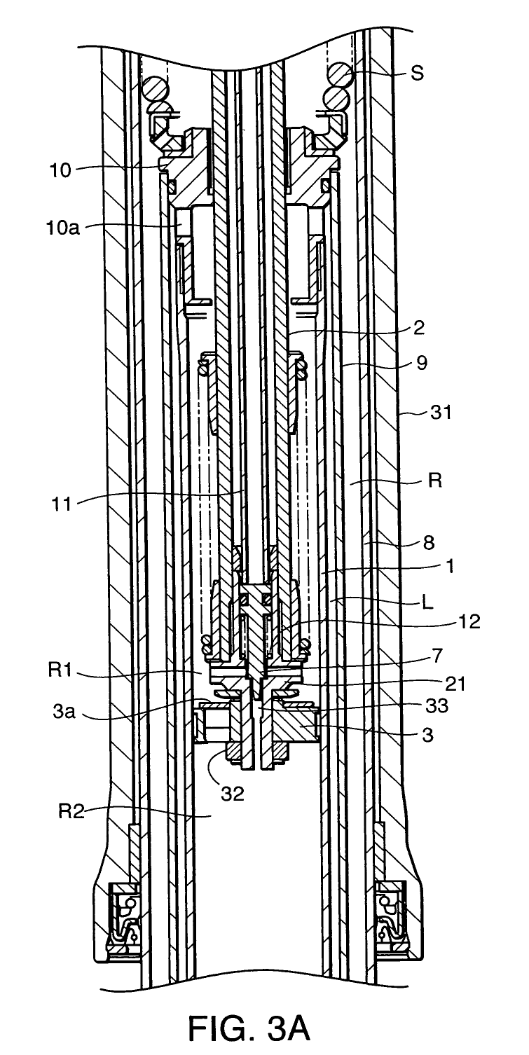

Referring to FIG. 2, the hydraulic shock absorber according to this invention will be compared with a hydraulic shock absorber according to the prior art. In the hydraulic shock absorber according to the prior art, the first oil chamber R1 and the tank T are connected via a communicating passage 62 in which a variable orifice 61 is installed. A contraction sub-valve 64 corresponding to the contraction damping valve 5 in the hydraulic shock absorber according to this invention is provided between the second oil chamber R2 and the tank T in parallel with the check valve 6. The piston 3 is provided with an elongation damping valve 4 and a contraction damping valve 63 which are disposed in parallel with each other.

In the hydraulic shock absorber according to the prior art, a shortage of working oil in the second oil chamber R2 when the piston 3 performs an elongation stroke is represented by the sum of “cross-sectional area of piston rod 2× stroke distance of piston 3” and “amount of working oil which has flowed out from second oil chamber R2 to tank T via communicating passage 62”.

In the hydraulic shock absorber according to this invention, the variable orifice 61 and the communicating passage 62 are not provided. When the piston 3 performs an elongation stroke, therefore, the working oil in the contracting first oil cylinder R1 cannot flow into the reservoir R2 and the entire amount of the surplus working oil in the first oil chamber R1 flows into the second oil chamber R2 via the elongation damping valve 4. Accordingly, the shortage of working oil in the second oil chamber R when the piston 3 performs an elongation stroke is represented only by an amount corresponding to “cross-sectional area of piston rod 2× stroke distance of piston 3”.

To summarize the above, the amount of working oil supplied from the tank T to the second oil chamber R2 in the elongation stroke of the piston 3 in the hydraulic shock absorber according to this invention, is smaller than that of the hydraulic shock absorber according to the prior art. Even when the piston 3 performs an elongation stroke at a high speed, therefore, a tentative negative pressure due to insufficient supply of working oil does not occur in the second oil chamber R2.

Accordingly, when the piston 3 shifts from the elongation stroke to the contraction stroke, the contraction damping valve 5 generates a predetermined contraction damping force immediately after the start of the contraction stroke, and hence the hydraulic shock absorber demonstrates a preferable damping force generation response. In other words, the capacity of the check valve 6 can be set smaller than that of the hydraulic shock absorber according to the prior art.

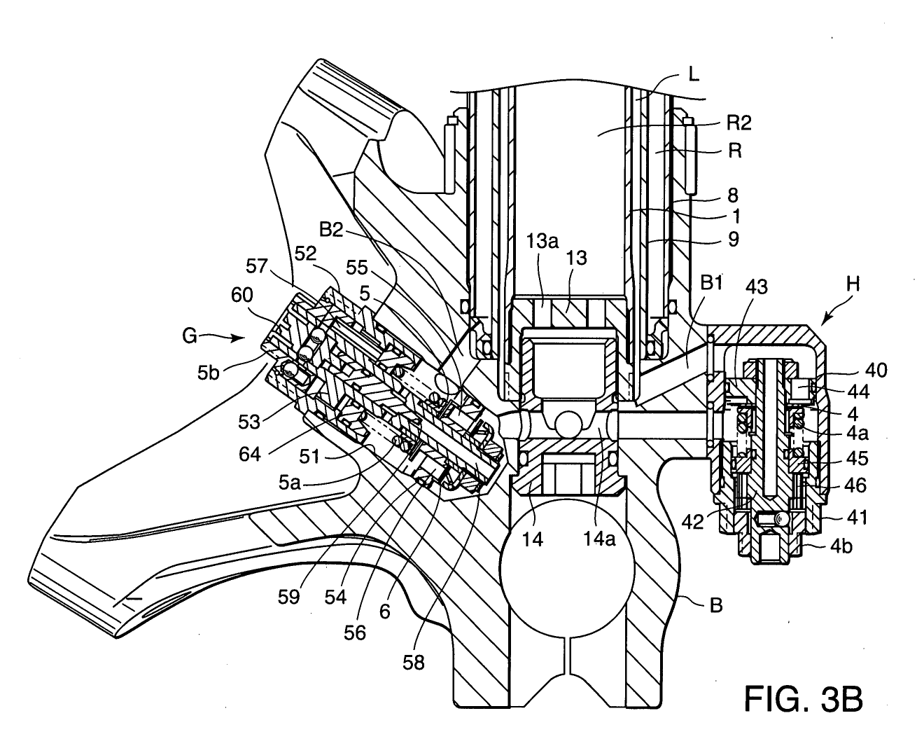

Referring to FIGS. 3A and 3B, a hydraulic shock absorber according to a further embodiment of this invention will be described.

The hydraulic shock absorber according to this embodiment comprises an inner tube 8 connected to a wheel axis of a front wheel and an outer tube 31 connected to handlebars of the motorcycle. The hydraulic shock absorber constitutes a so-called inverted front fork that absorbs oscillation of the front wheel of the motorcycle due to road surface undulation through elongation and contraction of the inner tube 8 and the outer tube 31.

The outer tube 31 and the inner tube 8 are biased in a direction to be removed from each other by a suspension spring S.

A bracket B is screwed onto the outer periphery of a lower end of the inner tube 8. A sleeve 9 is disposed on the inner side of the inner tube 8 coaxially therewith. The bracket B supports lower ends of the sleeve 9 and the cylinder 1.

A reservoir R is provided in a space between the inner tube 8 and the sleeve 9 having an annular cross-section. A communicating passage L is provided in a space between the cylinder 1 and the sleeve 9 having an annular cross-section.

The communicating passage L is closed by a plug 10 that is screwed into the inner periphery of an upper end of the cylinder 1. The piston rod 2 penetrates the plug 10.

The sleeve 9 is gripped between the plug 10 and the bracket B by screwing the plug 10 into the inner periphery of the upper end of the cylinder 1.

A communicating hole 10a is formed in the plug 10 to connect the first oil chamber R1 on the inner side of the cylinder 1 and the communicating passage L on the outside of the cylinder 1.

The piston rod 2 is formed into a cylindrical shape and a tip member 21 is screwed into the inner periphery of a tip of the piston rod 2. The piston 3 is secured onto the outer periphery of the tip member 21 by a nut 32.

A check valve 3a is mounted on the piston 3 to allow the working oil to flow from the second oil chamber R2 to the first oil chamber R1 while preventing the working oil from flowing in the opposite direction.

A bypass passage 33 which bypasses the check valve 3a is formed through the tip member 21. A bypass valve 7 is installed in the bypass passage 33. The bypass valve 7 is constituted by a needle valve. The bypass valve 7 is supported downward by a tip of a push rod 11 which is inserted into the piston rod 2 from outside, against a spring 12 which biases the bypass valve 7 upward. By operating the push rod 11 from outside to displace the bypass valve 7 downward against the biasing force of the spring 12, the flow cross-sectional area of the bypass passage 33 is reduced. The bypass passage 33 may be referred to as a second bypass passage.

The bypass valve 7 allows a small amount of working oil to flow from the first oil chamber R1 to the second oil chamber R2 under a smaller flow resistance than that of the elongation damping valve 4 when the piston 3 performs an elongation stroke at a speed that is not high enough to open the elongation damping valve 4. In other words, when the piston 3 performs an elongation stroke at a low speed, the working oil in the first oil chamber R1 flows out through the bypass valve 7 without opening the elongation damping valve 4 and generates a smaller elongation damping force than in the case where the working oil passes through the elongation damping valve 4.

A bottom cap 13 is screwed into the inner periphery of the lower end of the cylinder 1. A tightening bolt 14 is then screwed into the inner periphery of the bottom cap 13 through a fitting hole formed in the bracket B. The fitting hole has an opening on the bottom surface of the bracket B. The tightening bolt 14 is operated through the opening of the fitting hole from a lower side.

The bottom cap 13 has a port 13a connecting the second oil chamber R2 and a port 14a formed in the tightening bolt 14. The port 14a communicates with a passage B1 via the elongation damping valve 4. The passage B1 is formed in the bracket B so as to be connected to the communicating passage L, and hence to the first oil chamber R1, permanently.

The port 14a also communicates with a passage B2 via the contraction damping valve 5 and the check valve 6, which are installed in parallel with each other in the bracket B. The passage B2 is formed in the bracket B so as to be connected permanently to the reservoir B.

The elongation damping valve 4, which connects the passage B1 and the port 14a, is provided in the form of an assembly H fixed to the bracket B. The contraction damping valve 5 and the check valve 6, which connect the passage B2 and the port 14a in parallel, are provided in the form of an assembly G fitted into the bracket B. It should be noted that the assembly H may be referred to as a first assembly and the assembly G may be referred to as a second assembly.

The assembly H is fixed to a side face of the bracket B in which an opening of the passage B1 and an opening of the port 14a are formed. The assembly H comprises a housing 40 fixed to the side face of the bracket B, a cylindrical cap 41 screwed into the inner periphery of the housing 40 from a lower side, and a holder 42 penetrating the cap 41. The holder 42 and the cap 41 are engaged by a screw.

A disk 43 is fixed onto the tip of the holder 42 so as to contact the inner periphery of the housing 40 and separate the port 14a from the passage B1. A port 44 that connects the passage B1 and the port 14a is formed through the disk 43. The elongation damping valve 4 is constituted by a laminated leaf valve fitted onto the outer periphery of the holder 42 so as to close the port 44.

The elongation damping valve 4 is biased in a direction to close the port 44 by a coil spring 4a disposed axially along the outer periphery of the holder 42. The coil spring 4a may be referred to as a first spring. A spring seat 45 that is supported by an adjuster 4b via pins 46 supports the coil spring 4a. The adjuster 4b is fitted into the inner periphery of the cap 41 so as to be exposed to the downside of the cap 42.

According to the construction of the elongation damping valve 4 described above, the spring load of the coil spring 4a can be adjusted by turning the adjuster 4b from the outside of the housing 40. Adjusting the spring load of the coil spring 4a means adjusting the damping force generated by the elongation damping valve 4.

The assembly G is fitted into a hole portion 51 formed in the bracket B on the opposite side of the assembly H. An opening of the passage B2 and an opening of the port 14a, which respectively face the hole portion 51, are formed in the bracket B. The assembly G comprises a cylindrical cap 52 screwed into the hole portion 51 and a hollow holder 53 screwed into the inner periphery of the cap 52.

A disk 54 is fixed onto the tip of the holder 53 so as to contact the hole portion 51 and separate the passage B2 from the port 14a. A port 55 that connects the passage B2 and the port 14a is formed through the disk 54. The contraction damping valve 5 is constituted by a laminated leaf valve fitted onto the outer periphery of the holder 53 so as to close the port 55.

The contraction damping valve 5 is biased by a coil spring 5a disposed axially along the outer periphery of the holder 53 in a direction to close the port 55. The coil spring 5a may be referred to as a second spring. A spring seat 64 that is supported by an adjuster 5b via pins 57 supports the coil spring 5a. The adjuster 5b is fitted into the inner periphery of the cap 52 so as to be exposed to the outside of the bracket B.

According to the construction of the contraction damping valve 5 described above, the spring load of the coil spring 5a can be adjusted by turning the adjuster 5b from the outside of the bracket B. Adjusting the spring load of the coil spring 5a means adjusting the damping force generated by the contraction damping valve 5.

The check valve 6 is mounted on the disk 54 so as to face a port 56 formed through the disk 54 in parallel with the port 55. The check valve 6 allows the working oil to flow from the passage B2 to the port 14a without resistance while preventing the working oil from flowing in the opposite direction.

A bypass passage 58 is formed through a hollow space of the holder 53 so as to bypass the contraction damping valve 5 and connect the port 14a and passage B2 directly. A bypass valve 59 is installed in the bypass passage 58. The bypass passage 58 may be referred to as a first bypass passage.

The bypass valve 59 is constituted by a needle valve screwed into the inner periphery of the holder 53. The bypass valve 59 engages with an adjuster 60 accommodated in the hollow space of the holder 53 so as to allow linear displacement but prevent rotational displacement relative to the adjuster 60. The adjuster 60 is exposed to the outside of the bracket B. By turning the adjuster 60 from the outside of the bracket B, the bypass valve 59 increases or decreases the flow cross-sectional area of the bypass passage 58.

The bypass valve 59 allows a small amount of working oil to flow from the second oil chamber R2 to the reservoir R under a smaller flow resistance than the contraction damping valve 5 when the piston 3 performs a contraction stroke at a speed that is not high enough to open the contraction damping valve 5.

In other words, when the piston 3 performs a contraction stroke at a low speed, the working oil in the second oil chamber R2 flows out through the bypass valve 59 without opening the contraction damping valve 5 while generating a smaller elongation damping force than the contraction damping valve 5.

In other words, when the piston 3 performs a contraction stroke at a low speed, the working oil in the second oil chamber R2 flows out through the bypass valve 59 without opening the contraction damping valve 5 while generating a smaller contraction damping force than the contraction damping valve 5. The bypass valve 59 has a function for preventing the contraction damping valve 5 from generating an excessive damping force when the piston performs a contraction stroke at a low speed.

The hydraulic circuit of the front fork as configured above comprises the entire hydraulic circuit shown in FIG. 1, and hence brings about the same effect as the hydraulic shock absorber described with reference to FIG. 1. This front fork further comprises the bypass passage 33 and the bypass valve 7 to allow a part of working oil in the first oil chamber R1 to flow into the second oil chamber R2 when the piston 3 performs an elongation stroke at a low speed. This function appears to be similar to that of the communicating passage 62 and the variable orifice 61 in the prior art hydraulic shock absorber described with reference to FIG. 2.

However, the bypass passage 33 in this front fork allows the working oil to flow from the first oil chamber R1 to the second oil chamber R2, not from the first oil chamber R1 to the reservoir R as in the case of the communicating passage 62 and the variable orifice 61 according to the prior art. In this front fork, therefore, the shortage of working oil in the second oil chamber R2 when the piston 3 performs an elongation stroke is represented only by an amount corresponding to “cross-sectional area of piston rod 2×stroke distance of piston 3”. Accordingly, with respect to the damping force generated when the piston 3 shifts from the elongation stroke to the contraction stroke, this front fork indicates a similarly high response to that of the shock absorber shown in FIG. 1.

Further, since the elongation damping valve 4 is installed in the bracket B in the form of the assembly H, and the contraction damping valve 5 and check valve 6 are installed in the bracket B in the form of the assembly G, maintenance of these valves can be performed easily in this front fork. Still further, the assemblies H and G comprise the adjusters 4b, 5b and 59 to adjust the damping forces generated in the elongation damping valve 4 and the contraction damping valve 5, and hence the damping forces of the elongation damping valve 4 and the contraction damping valve 5 can be adjusted simply by turning the adjusters 4b, 5b and 59.

The contents of Tokugan 2007-183487, with a filing date of Jul. 12, 2007 in Japan, are hereby incorporated by reference.

Although the invention has been described above with reference to certain embodiments, the invention is not limited to the embodiments described above. Modifications and variations of the embodiments described above will occur to those skilled in the art, within the scope of the claims.

For example, the hydraulic shock absorber according to this invention should not be limited to the front fork described with reference to FIG. 3, but can be applied to various shock absorbers including those interposed between a vehicle body and a wheel of a four-wheel vehicle.

When the hydraulic shock absorber to this invention is applied to a front fork, the front fork should not be limited to an inverted type, in which the inner tube is connected to the wheel axis and the outer tube is connected to the handle bars, and is also applicable to a front fork of an upright type in which the inner tube is connected to the handlebars and the outer tube is connected to the wheel axis.

The embodiments of this invention in which an exclusive property or privilege is claimed are defined as follows:

What is claimed is:

1. A hydraulic shock absorber comprising:
a cylinder;
a piston accommodated in the cylinder;
a piston rod connected to an end of the piston and protruding axially from the cylinder;
a first oil chamber separated by the piston around the piston rod within the cylinder;
a second oil chamber separated by the piston on the opposite side of the piston to the piston rod;
a communicating passage disposed on the outside of the cylinder to connect the first oil chamber and the second oil chamber; and
an elongation damping valve installed in the communicating passage to allow a working oil to flow from the first oil chamber to the second oil chamber under a predetermined damping force while preventing the working oil from flowing in the opposite direction.

2. The hydraulic shock absorber as defined in claim 1, further comprising a reservoir disposed on the outside of the cylinder to store the working oil, a contraction damping valve which allows the working oil to flow from the second oil chamber to the reservoir under a predetermined damping force while preventing the working oil from flowing in the opposite direction, and a first check valve disposed in parallel with the contraction damping valve to allow the working oil to flow from the reservoir to the second oil chamber while preventing the working oil from flowing in the opposite direction.

3. The hydraulic shock absorber as defined in claim 2, further comprising a bracket which supports a base of the cylinder, a sleeve fixed to the bracket to cover the outer periphery of the cylinder, an inner tube fixed to the bracket to cover the outer periphery of the sleeve, wherein the communicating passage is provided in a space formed between the cylinder and the sleeve, the reservoir is provided in a space between the sleeve and the inner tube, the elongation damping valve is fixed to the bracket in the form of a first assembly, and the contraction damping valve and the first check valve are fixed to the bracket in the form of a second assembly.

4. The hydraulic shock absorber as defined in claim 3, wherein the first assembly comprises a first spring which biases the elongation damping valve in a direction to close the communicating passage and an adjuster to adjust a spring load of the first spring according to an operation from the outside of the first assembly, and the second assembly comprises a second spring which biases the contraction damping valve in a direction to prevent the working oil from flowing from the second oil chamber to the reservoir and an adjuster which adjusts a spring load of the second spring according to an operation from the outside of the second assembly.

5. The hydraulic shock absorber as defined in claim 4, wherein the second assembly further comprises a first bypass passage which connects the second oil chamber and the reservoir in parallel with the contraction damping valve and the check valve, and a valve which is operated from the outside of the second assembly to adjust a flow cross-sectional area of the first bypass passage.

6. The hydraulic shock absorber as defined in claim 1, wherein the piston comprises a second check valve which allows the working oil to flow from the second oil chamber to first oil chamber while preventing the working oil from flowing in the opposite direction.

7. The hydraulic shock absorber as defined in claim 6, further comprising a second bypass passage which connects the second oil chamber and the first oil chamber in parallel with the second check valve, and a push rod which penetrates the piston rod so as to vary a flow cross-sectional area of the second bypass passage according to an operation from the outside of the hydraulic shock absorber.
